(19) United States
(12) Patent Application Publication
(10) Pub. No.: US 2008/0165025 A1
(43) Pub. Date: Jul. 10, 2008

(54) Radio remote control

(76) Inventor: Erwin Morath, Lauterach (DE)

Correspondence Address: DILWORTH & BARRESE, LLP, 333 EARLE OVINGTON BLVD., SUITE 702, UNIONDALE, NY, 11553, US

(21) Appl. No.: 11/986,421

(22) Filed: Nov. 21, 2007

(30) Foreign Application Priority Data
Nov. 21, 2006 (DE) UM 202006017729.9

(51) Int. Cl. G05B 19/04

(52) U.S. Cl. 340/825.23; 455/41.2

(57) ABSTRACT

The present invention relates to a radio remote control for controlling one or more functions of a crane, preferably of a mobile crane, wherein the radio remote control comprises a hand-held transmitter, whose hardware components are not adapted to the type or configuration of the crane and thus are identical for a plurality of cranes differing in type or configuration, and which is programmable for the purpose of adaptation to the type or configuration of the crane whose function or functions should be controlled by means of the hand-held transmitter.

### BACKGROUND OF THE INVENTION

This invention relates to a radio remote control for controlling one or more functions of a crane, preferably of a mobile crane.

In cranes known from the prior art, wire-bound remote controls are utilized for mounting means and operations, such as bolting the boom parts, ballasting, supporting, adjusting the supporting base, mounting hinged jibs, mounting auxiliary winches, erecting the TA guy, mounting the main boom, etc. For this purpose, for instance three or four separate remote controls are provided on the crane, by means of which said auxiliary functions can be controlled. In part, the auxiliary functions are also controlled from the crane cabin, which, however, involves the disadvantage that there is no visual contact with the controlled function or the function to be controlled. It is also known to observe the controlled function via camera images, which requires the presence of corresponding cameras.

The use of a wire-bound remote control is disadvantageous, as the cable is disturbing in principle. Apart from this, practicability may possibly be restricted. The radius of movement of the operator is limited by the cable length. The cable must mechanically be mounted on the crane, which involves much effort. A further disadvantage consists in that the cable is susceptible to mechanical damage, so that in particular with respect to the possibly harsh operating conditions an increased probability exists that a remote control will fail due to the mechanical damage of the cable.

Furthermore, radio remote controls, i.e. wireless remote controls, are known from the prior art, by means of which the disadvantages resulting from the presence of a cable in wire-bound remote controls are overcome, but known radio remote controls involve the disadvantage that the same must each be adjusted to a certain type of crane or a certain customer-specific crane configuration, i.e. are not universally applicable. As in principle every crane has its own operating elements and functions, which generally differ from those of other cranes, the radio remote controls thus also differ from crane to crane, which not only adds to the manufacturing costs thereof, but also correspondingly increases warehousing costs.

### SUMMARY OF THE INVENTION

Therefore, it is the object underlying the invention to develop a radio remote control as mentioned above such that the same can be produced at comparatively low cost and involves reduced warehousing costs as compared to known radio remote controls.

This object is solved by a radio remote control with the features herein. Accordingly, it is provided that the radio remote control comprises a hand-held transmitter or consists of a hand-held transmitter which includes hardware components that are not adapted to the type or configuration of the crane and thus are identical for different crane types or configurations independent of the type or special configuration of the crane, and which is freely programmable for the purpose of adaptation to the type or special configuration of the crane whose function(s) should be controlled by means of the radio remote control.

Subject-matter of the invention thus is a universal radio remote control or a universal hand-held transmitter, in which a special adaptation of the hardware of the hand-held transmitter to crane- or customer-specific special constructions is omitted. Thus, the specific adaptation of the hand-held transmitter is not effected via the hardware, but via the possibility of freely programming the hand-held transmitter. This is true, for instance, for visualizing the display and assigning keys in the hand-held transmitter.

In a preferred aspect of the invention, the hand-held transmitter has a full-graphics display, in which for instance certain functions or parts of the crane, which play a role for the planned activity, or the position of these parts are represented.

In a further aspect of the invention it is provided that the hand-held transmitter includes one or more function keys which consist of at least two actuating elements, one of which constitutes an on/off key and another one constitutes an analogue key responding to the actuating pressure. Thus, the actuator is of the two-channel type. It is conceivable that the operator of the hand-held transmitter thus can operate analogous functions by means of a varying actuating force. This is advantageous, for instance, when certain parameters should be varied continously or also incrementally. One example is bolting, which can be performed with variable bolt speed, which can be effected, as stated above, by varying the actuating pressure of the correspondingly assigned function key of the hand-held transmitter of the radio remote control.

In a further aspect of the invention it is provided that the hand-held transmitter includes an enabling key and/or an emergency stop button. Preferably, it is provided that the hand-held transmitter has a very compact design, i.e. the usual actuating means such as master switches etc. are omitted.

In a further aspect of the invention it is provided that radio transmission is realized by Bluetooth, infrared or radio. Transmission by Bluetooth involves the advantage that it is permitted in all countries. It should be noted, however, that the invention is not restricted to this transmission technology and that other transmission technologies can also be employed, by means of which wireless transmission of signals or information is possible. The hand-held transmitter thus can have transmitting means which are configured such that the signals emitted by the hand-held transmitter are transmitted wireless, for instance by Bluetooth. A connection or data transfer via cable or docking station to a further hand-held transmitter, for instance, also is conceivable.

The hand-held transmitter not only can have a transmitting means, by means of which the actuating actions of the operator are transmitted in the form of corresponding signals, but in a further possible aspect of the invention also receiving means, by means of which the hand-held transmitter receives signals. In this case, too, it can be provided that the signals are received by the hand-held transmitter for instance by Bluetooth.

In a further aspect of the invention it is provided that the radio remote control furthermore comprises one or more master parts, which have receiving means by means of which the signals emitted by the hand-held transmitter can be received. It is conceivable that the crane comprises only one such master part or also a plurality of master parts, which can be addressed by means of a transmitter or receive the signals emitted by the hand-held transmitter and utilize or forward the same for controlling the crane or crane functions. One or more hand-held transmitters can be associated to one master part, or one or more master parts can be associated to one hand-held transmitter.

In a preferred aspect of the invention, free programmability not only refers to the hand-held transmitter, but also to said master part(s). The master part can include control links, which are designed to be freely programmable in the master part, so that it can be chosen which control functions should be performed or switched via the master part.

Preferably, it is provided that the master part has interfaces, preferably bus interfaces with the crane or vehicle control. The interfaces preferably are of the two-channel type (2×CAN and 2×LSB). Alternatively or in addition, the master part and the receiving means also can be of the two-channel type. It is conceivable that the entire arrangement is of the two-channel type, which involves an advantage in terms of safety.

Moreover, solenoid valves can directly be connected, for which purpose the radio remote control has power or switching outputs. Corresponding actuators can also be driven via the CAN bus.

In a further aspect of the invention it is provided that the master part has transmitting means by means of which signals can be transmitted to the hand-held transmitter. In this embodiment of the invention, communication thus is effected not only from the hand-held transmitter to the master part, but bidirectionally, i.e. also in the opposite direction from the master part to the hand-held transmitter. This can be required or be utilized for transmitting data or information to the hand-held transmitter(s) by means of the master part. For instance, these data or information can be the software for programming the hand-held transmitter.

It is conceivable, for instance, that a memory means exists on the crane, from which the software can be downloaded, which allows for freely programming the master part(s) or the hand-held transmitter(s). Thus, an autoconfiguration of the hand-held transmitter also is conceivable, which is effected in that upon contacting the master part, the hand-held transmitter is programmed by the same or provided with software corresponding to the concrete configuration of the crane.

For instance, the visualization of the display and the assignment of the keys in the hand-held transmitter can be defined by the software. Thus, any kind of control applications can be programmed on the radio remote control or on the hand-held transmitter. Preferably, it is provided that any kind of graphic displays and also status messages can be visualized in the hand-held transmitter. Such status messages for instance can be diagnostic messages, which are transmitted to the hand-held transmitter by means of the master part. It is thus possible that the operator receives a diagnostic message on the hand-held transmitter and then can investigate a possible error on site with the aid of the diagnostic message.

It is also conceivable to arrange one or more displays on a radio remote control or other unit with which the hand-held transmitter is connected. The same can represent for instance the assignment of keys or the assignment of master switches.

As stated above, a preferred aspect of the invention consists in that the software for programming the hand-held transmitter and possible diagnostic messages are transmitted from the master part to the hand-held transmitter by wireless or wire-bound transmission or via a plug connection. It is, however, also conceivable that the hand-held transmitter receives the software for programming and also the diagnostic message from some other point. In a further aspect of the invention it is provided that the hand-held transmitter can be operated independent of the master parts.

In a further aspect of the invention it is provided that the radio remote control includes a plurality of master parts which are configured such that data can be exchanged between the master parts. It is also conceivable that the radio remote control includes a plurality of hand-held transmitters, which can also be configured such that they communicate with each other or that data are transmitted from the one to the other hand-held transmitter.

Furthermore, it is conceivable that one hand-held transmitter is associated to only one master part or that one hand-held transmitter is associated to a plurality of master parts. It is also conceivable that one master part only communicates with one hand-held transmitter. It is, however, likewise possible that one master part is associated to a plurality of hand-held transmitters.

The invention furthermore relates to a radio remote control system for controlling one or more functions of a crane, preferably of a mobile crane, which is characterized in that the radio remote control system includes a first radio remote control which is configured such that it can be connected with a second radio remote control. It is furthermore conceivable that the radio remote control system includes a first unit which can be connected with a second radio remote control. The first unit can, but need not be configured as a radio remote control. The term “second radio remote control” thus does not necessarily mean that a further “first” radio remote control must be provided. It is possible that exclusively the second radio remote control or the hand-held transmitter is transmitting.

It is conceivable that the first unit and the second radio remote control are configured such that one or more functions of the first unit are performed by the second radio remote control or vice versa, when the first unit and the second radio remote control are connected with each other.

The type of connection between the two radio remote controls or between the first unit and the second radio remote control actually can be chosen as desired. It is conceivable that the connection between the two radio remote controls or between the first unit and the second radio remote control is configured as a plug connection comparable with a docking station. It is conceivable that when accommodating the second radio remote control in the first radio remote control or unit, a connection is made at the same time, which serves the transmission of energy and/or data.

The second radio remote control can be a hand-held transmitter of a radio remote control according to the description herein. In principle, it can be provided that the radio remote control system includes features of the radio remote control of the invention. Preferably, it is provided that the radio remote controls are configured such that one or more functions of one radio remote control are performed by the other radio remote control when the radio remote controls are connected with each other.

It is conceivable that upon connection the operating elements of the hand-held transmitters are fully or at least partly available for control purposes.

In principle, it can be provided that the hand-held transmitter and/or the radio remote control dynamically sends protocols and expects the response of the receiver within a certain period. In this way, the proper execution of the commands can be ensured.

It is also conceivable that the hand-held transmitter can be connected with the crane control. In one aspect of the invention it is possible, for instance, that the hand-held transmitter can be connected with the crane control by means of a connection, for instance by a connection corresponding to a docking station, in the cabin of the crane. It can be provided that the hand-held transmitter, in particular its keys and/or the screen, is assigned new functions. There can for instance be formed a fully equivalent on-board computer e.g. with a display of the velocities, the operating hours (with zero function, which for billing purposes effects the summation of the operating hours for travel and work on the construction site), and the like.

It is furthermore conceivable that the energy accumulator of the hand-held transmitter is charged in said docking station.

In principle, the hand-held transmitter can also be charged in the radio remote control or in the unit 1 as shown in FIG. 3 or 4 or also at some other point, for instance on a special tray in the crane. Charging can for instance be effected via a plug connection or cable.

The keys of the hand-held transmitter or radio remote control also can be assigned in different ways. For instance, a detailed error analysis can be performed. This function can also be available when the hand-held transmitter is not in the connected position or in the docking position as mentioned above.

It is conceivable that the user of the crane moves to the place where the error is located with the hand-held transmitter or the radio remote control in his hands. Thereby, many activities such as maintenance, repair or also assembly work can be performed without the aid of a second person.

In a further aspect of the invention it is conceivable that the crane can be operated either by means of the hand-held transmitter or radio remote control or by means of a unit with which the hand-held transmitter is connected or by means of the control means provided on the crane, preferably in the crane operator cabin. In this way, the possibility of a dual operation can be excluded via the control. For this purpose, switching may be necessary in principle.

The invention furthermore relates to a crane, preferably a mobile crane, which is characterized in that it includes a radio remote control and/or a radio remote control system in accordance with the invention. The crane can have one or more master parts which are disposed on the crane and by means of which signals from the hand-held transmitter are received.

It is conceivable to use one hand-held transmitter for addressing a plurality of master parts. For instance, one master part can be mounted in the undercarriage and one further master part can be disposed in the uppercarriage, which can both be addressed by only one hand-held transmitter. Thus, functions of the undercarriage and of the uppercarriage can independently be controlled as desired.

It is furthermore conceivable that the crane includes a boom which likewise has its own master part.

By means of a serial connection of the master part with the crane control, any functions of the crane can be remote-operated.

### BRIEF DESCRIPTION OF THE DRAWINGS

The invention furthermore relates to a hand-held transmitter of a radio remote control in accordance with the invention and a master part of the radio remote control in accordance with the invention.

Further details or advantages of the invention will be explained in detail with reference to an embodiment illustrated in the drawing.

FIG. 1 shows a schematic top view of a hand-held transmitter of the radio remote control in accordance with the invention.

FIG. 2 shows a schematic representation of a radio remote control of the invention with a plurality of master parts and hand-held transmitters.

FIG. 3 shows a schematic representation of a radio remote control system in accordance with the invention.

FIG. 4 shows a representation of a radio remote control system in accordance with the invention with a hand-held transmitter accommodated in the radio remote control.

### DESCRIPTION OF THE PREFERRED EMBODIMENTS

The function keys F1-F9, F0 of the hand-held transmitter of the invention as shown in FIG. 1 are configured such that all or some of them consist of two actuators. In the area enclosed by the function keys, the full-graphics display of the hand-held transmitter is disposed, on which it is displayed for the operator which function can be activated by actuating the function key. In the embodiment shown here it is provided that by means of the function keys F5, F7, F8, F0 an individual sliding beam 1, 2, 3 or 4 can be selected. By means of the function key F4, the crane symbol can be rotated in 90° increments.

All or some of the illustrated function keys can also be configured as keys of a touchscreen, i.e. the display of the hand-held transmitter also might be configured as a touchscreen.

The function key F9 relates to switching on and off the sliding beam illumination.

The swivel movement of the sliding beam selected via the function keys F5, F7, F8, F0 is effected by means of the function keys F2 and F3, the individual swivel angles being indicated in degrees in the display. As explained, the actuators are of the two-channel type, one actuator concerning an on/off key and another actuator concerning a pressure-dependent analogue key. When the function key F2 is actuated, for instance, the previously selected sliding beam performs a swivel movement, which is performed the faster the more pressure is applied onto the key. Thus, an analogue function can be operated by a varying actuating force.

In one example, the crane position “to the rear” can be chosen. Then, the sliding beam 4 is selected via the function key F8, the sliding beam illumination is switched off via the function key F9, and a movement of the selected sliding beam 4 within the swivelling range can be effected via the function keys F2 (downwards) and F3 (upwards).

On the bottom surface of the hand-held transmitter, e.g. an emergency stop key can be provided.

The hand-held transmitter can include an ergonomic holder with an enabling key.

Preferably, the keys of the hand-held transmitter are dimensioned such that they can also be operated with gloves.

Finally, the hand-held transmitter can also include a glare protection.

The present invention in particular has the advantage that a universally applicable hand-held transmitter of the remote control is employed, which in terms of hardware is not adapted to crane- or customer-specific special constructions or optional features. Such adaptation is effected via the free programmability of the hand-held transmitter.

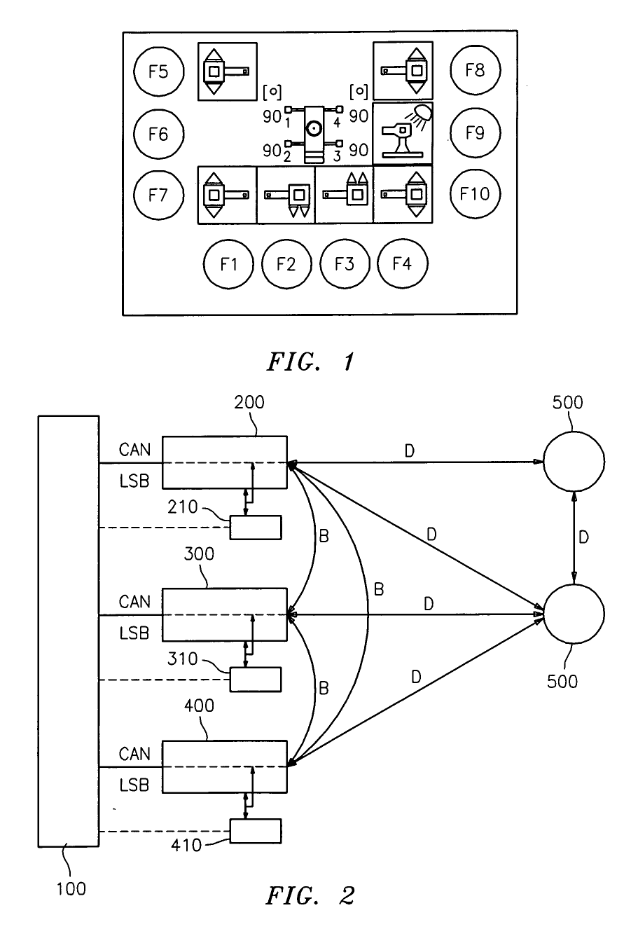

FIG. 2 shows a schematic representation of the crane control 100, which is connected with master parts 200, 300, 400 via a CAN or LSB connection, the master parts being fully equivalent controls. The master parts each include first and second computers.

The reference numerals 210, 310, 410 designate corresponding crane functions which can each be controlled via the respective master part.

As can furthermore be taken from FIG. 2, the radio remote control comprises hand-held devices 500, 600, which communicate with each other and with the master parts via wireless or wire-bound connections. A connection via a docking station is also conceivable.

In FIG. 2, reference numeral D designates a data transfer via Bluetooth, infrared, radio, cable or a docking station, and reference numeral B designates a Bluetooth data transmission. As can be taken from FIG. 2, the master parts thus communicate with each other by Bluetooth in this embodiment. Different embodiments are also conceivable in terms of data transmission technology.

FIG. 2 furthermore shows that the hand-held transmitter 500 communicates with the master part 200 and with the hand-held transmitter 600. The hand-held transmitter 600 communicates with the hand-held transmitter 500 and with all three master parts 200, 300, 400. It can be provided, for instance, that the hand-held transmitter 500 can be coupled with the hand-held transmitter 600 comparable to a docking station, whereby the functions of the hand-held transmitter 500 are performed by the hand-held transmitter 600.

Of course, instead of the illustrated two hand-held transmitters more than two can be employed, and instead of the illustrated three master parts more than three master parts can be employed.

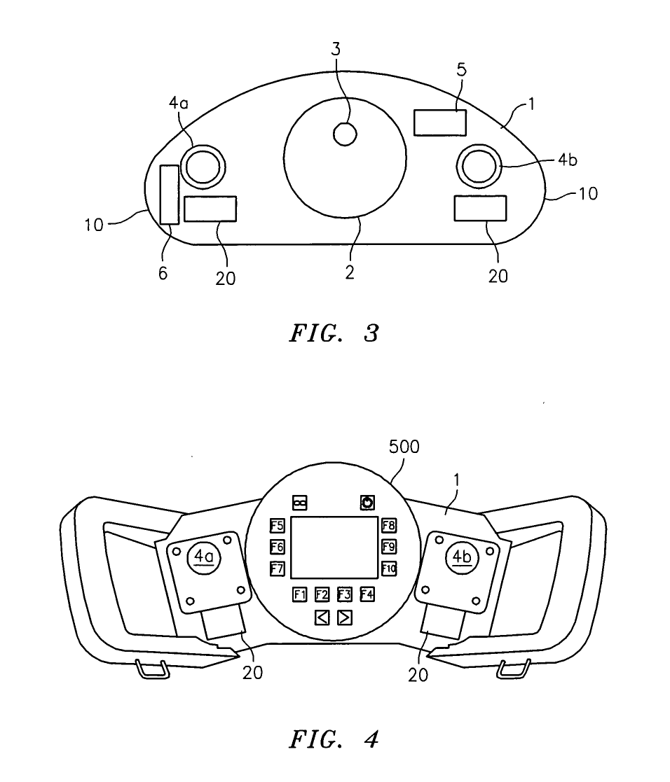

FIG. 3 finally shows a radio remote control system in accordance with the invention. The radio remote control system 1 is provided with a ribbon on holders 10 and can be put on by the crane operator. The radio remote control 1 is a complete radio remote control for the crane with all required functionalities. Thus, all crane functions can be performed outside the crane, a safe eye contact with the crane being of course necessary for safety reasons.

Since the eye contact with the crane movement performed represents an essential safety factor, it can be provided in one aspect of the invention that the crane operator must enter his current position, before crane movements can be performed. In accordance with this input of the position, the control then enables all or certain movements. One example is the extension of the sliding beams: When the crane operator is standing for instance on the left side of the crane, it can be provided that he can exclusively effect the movement of the sliding beams disposed on the left side of the crane. This is true independent of whether the radio remote control system in accordance with the present invention is formed only by the hand-held transmitter and/or by a further radio remote control/unit which can be connected with the hand-held transmitter.

Input can for instance be effected into the radio remote control system and/or into the hand-held transmitter.

Reference numerals 4a and 4b designate the master switches of the radio remote control 1.

Reference numeral 20 designates displays of the radio remote control 1, in which the current assignment of the master switches is represented.

The above-described hand-held transmitter of the radio remote control of the invention can be inserted into the radio remote control 1, i.e. into its slide-in module 2, comparable to a docking station, and thus is connected with the complete radio remote control 1. Functions of the hand-held transmitter, as in the present embodiment those of the enabling key, are performed by the radio remote control 1. The performance of further functions is of course also conceivable.

As can furthermore be taken from FIG. 3, a through hole 3 is provided in the bottom of the slide-in module 2, through which the emergency stop button of the hand-held transmitter can protrude, whereby its function can be maintained. As explained, the enabling key of the hand-held transmitter can be realized by the radio remote control 1.

For connecting the radio remote control 1 with the hand-held transmitter, an electronic unit 5 is provided. Reference numeral 6 designates a comparatively large energy accumulator which provides for an extended independent crane operation.

Furthermore, it can be provided that the unit 1 as shown in FIG. 3 is not a radio remote control, but that the unit 1 substantially serves for insertion or for data connection with the hand-held transmitter. In this case, the unit 1 can for instance be employed as an expansion module, which opens up further input possibilities. It is conceivable that only the hand-held transmitter is transmitting, but not the unit 1.

It is conceivable that the radio remote control or the unit 1 automatically recognizes the hand-held transmitter or that the hand-held transmitter automatically recognizes the radio remote control or the unit 1 (“plug-and-play principle”). It is possible, for instance, that the hand-held transmitter automatically recognizes the radio remote control or the unit 1 as a further input possibility. Furthermore, the optimum data transmission possibility between hand-held transmitter and radio remote control or unit 1 can be chosen. It is possible to perform the data transmission wireless, by means of a plug connection or also by cable.

FIG. 4 finally shows the hand-held transmitter 500, which is inserted into a slide-in module of the radio remote control 1. Reference numerals 4a, 4b again designate the master switches, whose assignment is represented in the displays 20.

Preferably, it is provided that the hand-held transmitter or the radio remote control does not drive other machines than the respective crane and that the crane does not react to commands of other remote controls. For this purpose, it can be provided that prior to delivery to the customer a corresponding pairing “hand-held transmitter/radio remote control—crane” is effected, so that in terms of software there is always a clear allocation of the hand-held transmitter or the radio remote control to the crane and vice versa.

However, this allocation need not be firmly specified, but can also be variable. It is conceivable, for instance, that the software which allocates a hand-held transmitter or a radio remote control to a crane is stored in the crane and can be loaded from there by the hand-held transmitter or by the radio remote control via wireless or wire-bound transmission. In this case, the hand-held transmitter or the radio remote control includes a data receiver. It is conceivable that the hand-held transmitter or the radio remote control includes a display or some other indication, by means of which it is indicated to which crane the hand-held transmitter or the radio remote control is allocated.

To prevent unauthorized use, it can be provided that a code must be entered for activating/using the hand-held transmitter and/or the radio remote control or unit 1, as shown in FIG. 3 or 4.

1. A radio remote control for controlling one or more functions of a crane, preferably of a mobile crane, wherein the radio remote control comprises a hand-held transmitter, whose hardware components are not adapted to the type or configuration of the crane and thus are identical for a plurality of cranes differing in type or configuration, and which is programmable for the purpose of adaptation to the type or configuration of the crane whose function or functions should be controlled by the hand-held transmitter.

2. The radio remote control according to claim 1, wherein the hand-held transmitter has a graphics display.

3. The radio remote control according to claim 1, wherein the hand-held transmitter includes one or more function keys which include of at least two actuating elements, one of which is an on/off key and another one of which is an analogue key responding to the actuating pressure.

4. The radio remote control according to claim 1, wherein the hand-held transmitter includes an enabling key and/or an emergency stop button.

5. The radio remote control according to claim 1, wherein the hand-held transmitter has sending or transmitting means which are configured such that the signals emitted by the hand-held transmitter are transmitted by Bluetooth, radio, infrared, cable or via a docking station.

6. The radio remote control according to claim 1, wherein the hand-held transmitter has receiving means, by means of which the hand-held transmitter receives signals.

7. The radio remote control according to claim 6, wherein the receiving means are configured such that signals transmitted by Bluetooth can be received with the receiving means.

8. The radio remote control according to claim 1, wherein the radio remote control furthermore comprises one or more master parts which have receiving means, by which the signals emitted by the hand-held transmitter can be received.

9. The radio remote control according to claim 8, wherein the radio remote control is configured such that by one hand-held transmitter two or more than two master parts can be addressed and/or that one master part is associated to two or more than two hand-held transmitters.

10. The radio remote control according to claim 8, wherein the master part includes control links which are freely programmable.

11. The radio remote control according to claim 8, wherein the master part has interfaces, preferably bus interfaces with the crane and/or travel control.

12. The radio remote control according to claim 11, wherein the interfaces are of the two-channel type.

13. The radio remote control according to claim 8, wherein solenoid valves are directly connected to the master part, which has power and/or switching outputs for driving the same.

14. The radio remote control according to claim 8, wherein the master part has transmitting means, by which signals can be transmitted to the hand-held transmitter.

15. The radio remote control according to claim 14, wherein the master part is configured such that software for programming the hand-held transmitter can be transmitted to the same by the master part.

16. The radio remote control according to claim 14, wherein the master part is configured such that diagnostic messages can be transmitted to the hand-held transmitter by the master part.

17. The radio remote control according to claim 1, wherein the radio remote control has a plurality of master parts, which are configured such that data can be transmitted from one to another master part.

18. The radio remote control according claim 1, wherein the radio remote control has a plurality of hand-held transmitters, which are configured such that data can be transmitted from one to another hand-held transmitter.

19. A radio remote control system for controlling one or more functions of a crane, preferably a mobile crane, wherein the radio remote control system includes a first radio remote control or some other first unit, with which a second radio remote control can be connected.

20. A radio remote control system including a first radio remote control or some other first unit, with which a second radio remote control can be connected, wherein the second radio remote control is the hand-held transmitter of a radio remote control according to claim 1.

21. The radio remote control system according to claim 19, wherein the radio remote controls are configured such that one or more functions of one radio remote control are performed by the other radio remote control when the radio remote controls are connected with each other, or that the first unit and the second radio remote control are configured such that one or more functions of the first unit are performed by the second radio remote control and/or vice versa, when the first unit and the second radio remote control are connected with each other.

22. The radio remote control system according to claim 19, wherein the connection between the two radio remote controls or between the first unit and the second radio remote control is configured as a plug connection.

23. The radio remote control system according to claim 19, wherein the first unit is configured as a mobile part or is fixed.

24. A crane, preferably a mobile crane, configured with at least one radio remote control according to claim 1.

25. The crane according to claim 24, wherein the crane has one or more master parts, which are disposed on the crane.

26. The crane according to claim 24, wherein the crane includes an uppercarriage and an undercarriage, which each have a master part.

27. The crane according to claim 24, wherein the crane includes a boom, which has a master part.

28. The hand-held transmitter of a radio remote control according to claim 1.

29. The master part of a radio remote control according to claim 8.
